(19) United States
(12) Patent Application Publication
(10) Pub. No.: US 2026/0235972 A1
(43) Pub. Date: Aug. 13, 2026

(54) ELECTROPHOTOGRAPHIC PHOTOSENSITIVE MEMBER, PROCESS CARTRIDGE AND ELECTROPHOTOGRAPHIC APPARATUS, AND METHOD OF PRODUCING ELECTROPHOTOGRAPHIC PHOTOSENSITIVE MEMBER

(71) Applicant: CANON KABUSHIKI KAISHA, Tokyo (JP)

(72) Inventors: IKUYO KUROIWA, Tokyo (JP); ERI FUJISAWA, Chiba (JP)

(21) Appl. No.: 19/533,900

(22) Filed: Feb. 9, 2026

(30) Foreign Application Priority Data
Feb. 12, 2025 (JP) 2025-021080

(51) Int. Cl. G03G 5/05; G03G 5/06; G03G 5/14; G03G 21/18

(52) U.S. Cl. CPC G03G 5/056; G03G 5/061443; G03G 5/14; G03G 21/1814

(57) ABSTRACT

To provide an electrophotographic photosensitive member excellent in scratch resistance, an electrophotographic photosensitive member including a surface layer containing a polymerized product of a polymerizable composition containing a compound A having a urethane structure and a methacryloyl group, wherein when, in a load-displacement curve measured by a dynamic nanoindentation method, a measured load value at a start of holding in a section in which a load is held for a certain time period is represented by W1, a measured load value at an end of the holding is represented by W2, a maximum displacement amount at the end of the holding is represented by ht, and an X-axis intersection point of a tangent line of an unloading curve at a point W2 (contact depth of an indenter) is represented by hc, the electrophotographic photosensitive member satisfies the following formulae: 25<W1<60 Formula (1); (W1−W2)/W1≤0.10 Formula (2); ht/hc≥1.5 Formula (3).

### BACKGROUND

### Field of the Technology

The present disclosure relates to an electrophotographic photosensitive member, a process cartridge and an electrophotographic apparatus each including the electrophotographic photosensitive member, and a method of producing the electrophotographic photosensitive member.

### Description of the Related Art

In recent years, an organic electrophotographic photosensitive member (hereinafter referred to as “electrophotographic photosensitive member”) to be mounted onto an electrophotographic apparatus has been required to be improved in mechanical durability (abrasion resistance) for the purposes of lengthening the lifetime of the electrophotographic photosensitive member and improving image quality at the time of repeated use thereof.

As a technology of improving the abrasion resistance of the electrophotographic photosensitive member, there is a disclosure of a technology including introducing a urethane structure into a polymerizable functional group of a surface layer of the electrophotographic photosensitive member. In US Patent Publication No. 2014/0186756, there is a disclosure of a technology intended to improve abrasion resistance by forming a surface layer from a compound containing, as polymerizable functional groups, a urethane structure and a polyacrylate structure, or a urethane structure and a polymethacrylate structure.

In addition, in U.S. Pat. No. 10,761,443, there is a disclosure of a technology intended to improve abrasion resistance by adopting a surface layer containing a polymerized product obtained by polymerizing a polymerizable charge-transporting compound in which a polymerizable functional group is an acryloyl group and which is free of a urethane structure, and further containing a non-charge-transporting compound having a urethane structure and an acrylate structure.

### SUMMARY

One aspect of the present disclosure is directed to providing an electrophotographic photosensitive member having improved scratch resistance during long-term use.

In addition, another aspect of the present disclosure is directed to providing a process cartridge including the electrophotographic photosensitive member, and an electrophotographic apparatus including the process cartridge.

In addition, another aspect of the present disclosure is directed to providing a method of producing the electrophotographic photosensitive member.

According to one aspect of the present disclosure, there is provided an electrophotographic photosensitive member including a surface layer containing a polymerized product obtained by polymerizing a polymerizable composition containing a compound A having a urethane structure and a methacryloyl group, wherein when, in a load-displacement curve measured by a dynamic nanoindentation method, a measured load value at a start of holding in a section in which a load is held for a certain time period is represented by W1, a measured load value at an end of the holding is represented by W2, a maximum displacement amount at the end of the holding is represented by ht, and an X-axis intersection point of a tangent line of an unloading curve at a point W2 (contact depth of an indenter) is represented by hc, the electrophotographic photosensitive member satisfies the following formulae (1) to (3).

$$25 < W 1 < 60 \qquad Formula ( 1 )$$

$$( W 1 - W 2 ) / W 1 \leq 0.1 \qquad Formula ( 2 )$$

$$ht / hc \geq 1.5 \qquad Formula ( 3 )$$

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view for illustrating an example of the configuration of an electrophotographic photosensitive member of the present disclosure.

FIG. 2 is a view for illustrating an example of a polishing machine using a polishing sheet.

FIG. 3 is a view for illustrating an example of the schematic configuration of a process cartridge including the electrophotographic photosensitive member of the present disclosure, and an electrophotographic apparatus including the process cartridge.

FIG. 4 is a schematic view for illustrating an example of a process cartridge including the electrophotographic photosensitive member of the present disclosure.

FIG. 5 is a schematic view for illustrating an example of an electrophotographic apparatus including the electrophotographic photosensitive member of the present disclosure.

FIG. 6 is a schematic graph showing an example of a load-displacement curve when the electrophotographic photosensitive member of the present disclosure is subjected to measurement by a dynamic nanoindentation method.

### DESCRIPTION OF THE EMBODIMENTS

The present disclosure is described in detail below by way of exemplary embodiments.

However, it has been found that, in each of the technologies disclosed in US Patent Publication No. 2014/0186756 and U.S. Pat. No. 10,761,443, scratch resistance may deteriorate owing to the introduction of the urethane structure, and there is room for improvement.

The disclosers have made investigations, and as a result, have found that the following electrophotographic photosensitive member has improved scratch resistance: the electrophotographic photosensitive member including a surface layer containing a polymerized product obtained by polymerizing a polymerizable composition containing a compound A having a urethane structure and a methacryloyl group, wherein when, in a load-displacement curve measured by a dynamic nanoindentation method, a measured load value at the start of holding in a section in which a load is held for a certain time period is represented by W1, a measured load value at the end of the holding is represented by W2, the maximum displacement amount at the end of the holding is represented by ht, and the X-axis intersection point of a tangent line of an unloading curve at a point W2 (contact depth of an indenter) is represented by hc, the electrophotographic photosensitive member satisfies the following formulae (1) to (3).

$$25 < W 1 < 60 \qquad Formula ( 1 )$$

$$( W 1 - W 2 ) / W 1 \leq 0.1 \qquad Formula ( 2 )$$

$$ht / hc \geq 1.5 \qquad Formula ( 3 )$$

The compound A is preferably a charge-transporting substance.

The disclosers have assumed the reasons why the electrophotographic photosensitive member of the present disclosure is excellent in scratch resistance to be as described below.

When a polymerized product having introduced thereinto a urethane structure is incorporated into the surface layer, the elasticity of the film improves. The electrophotographic photosensitive member includes a member to be brought into abutment therewith such as a cleaning blade for scraping off residual toner in image formation, and a rubbing scratch may be caused by rotation contact with such member. This becomes remarkable particularly when a hard and inelastic resin is used for the surface layer. When a resin having elasticity is used for the surface layer, an external force can be dispersed even when the external force is applied to the surface of the photosensitive member, and hence the resin is conceived to be effective in improving scratch resistance.

However, it has been found that depending on the structure of the polymerized product having introduced thereinto the urethane structure, the strength of the entire film becomes brittle, and rubbing scratches may increase starting from burrs generated by abrasion of the surface at the time of repeated use thereof.

In view of the foregoing, as a result of further investigations made by the disclosers, it has been found that in a photosensitive member including a surface layer containing a polymerized product obtained by polymerizing a compound A having a urethane structure and a methacryloyl group, a configuration capable of suppressing rubbing scratches due to long-term repeated use can be found by using numerical values obtained at the time of the measurement of the photosensitive member by a dynamic nanoindentation method as indices. Specifically, it has been found that the photosensitive member has improved scratch resistance when, in a load-displacement curve obtained by measuring the photosensitive member by the dynamic nanoindentation method, a measured load value at the start of holding in a section in which a load is held for a certain time period is represented by W1, a measured load value at the end of the holding is represented by W2, the maximum displacement amount at the end of the holding is represented by ht, and the X-axis intersection point of a tangent line of an unloading curve at a point W2 (contact depth of an indenter) is represented by hc, and the photosensitive member satisfies the following formulae (1) to (3) calculated from the respective values.

$$25 < W 1 < 60 \qquad Formula ( 1 )$$

$$( W 1 - W 2 ) / W 1 \leq 0.1 \qquad Formula ( 2 )$$

$$ht / hc \geq 1.5 \qquad Formula ( 3 )$$

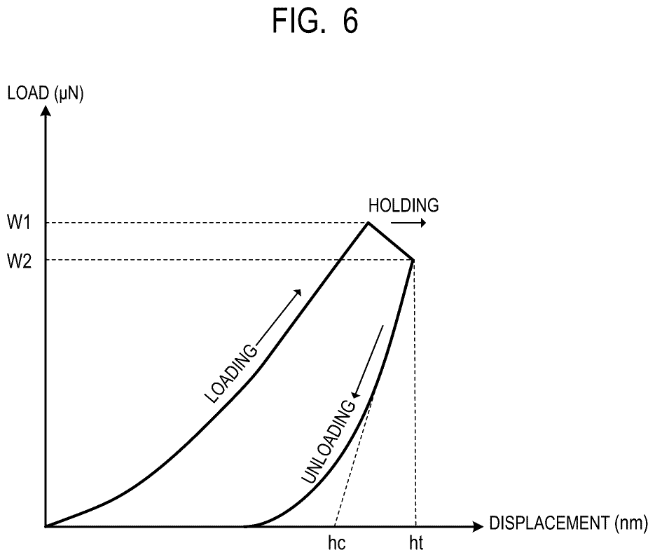

A schematic graph of the load-displacement curve is shown in FIG. 6.

In the dynamic nanoindentation method of the present disclosure, an operation was performed in which a load was applied to push a Berkovich indenter from a state in which the indenter was brought into contact with the surface of the photosensitive member, the load was then held for a certain time period, and the load was then removed. Vibration was applied to the indenter at a constant frequency, and the drag force received from the surface was measured and analyzed.

The formula (1) is described.

W1 shown in FIG. 6 represents the maximum load when the indenter is pushed in by applying a load. W1 that falls within the range of the formula (1) indicates that the electrophotographic photosensitive member has hardness capable of withstanding the image forming operation. A load at the point W1 of less than 25 indicates that the film is a soft film close to a gel, and a load at the point W1 of more than 60 indicates that the film has hardness of a resin that is hardly deformed such as that used as a mold material for injection molding.

Next, the formula (2) is described.

W2 shown in FIG. 6 represents a load value at the end of the holding in a period during which the load is held for a certain time period. The difference between the load value W1 at the start of the holding and the load value W2 at the end of the holding in the section in which the load is held for a certain time period is conceived to be an index for judging the strength of the film.

A large difference between the measured load value W1 at the start of the holding and the measured load value W2 at the end of the holding is large means that the drag force received from the film is gradually weakening. That is, it can be determined that the shape of the film cannot be maintained. A photosensitive member having a large difference between W1 and W2 tends to have weak strength of the film of the surface layer, and it is conceived that rubbing scratches are liable to occur starting from burrs generated by abrasion of the surface due to repeated use.

In the photosensitive member including the surface layer containing the polymerized product obtained by polymerizing the polymerizable compound having the urethane structure and the methacryloyl group of the present disclosure, the occurrence of rubbing scratches can be suppressed when (W1-W2)/W1, which is a decrease rate of the load of W1 and W2, is 0.10 or less.

Next, the formula (3) is described.

ht shown in FIG. 6 indicates the maximum displacement amount in the depth direction reached by the indenter after the load is applied to push the indenter and the load is held for a certain time period. hc represents an intersection point between the tangent line of the unloading curve at W2 and the X-axis when the load is removed, and indicates the contact depth of the indenter when the return amount of the film when the load is removed is taken into consideration. The difference between the maximum displacement amount ht and the X-axis intersection point hc of the tangent line of the unloading curve is conceived to be an index indicating the elasticity of the film. As the difference between ht and hc increases, the force of the film to return to its original state, that is, the elasticity increases, and the force applied from the outside can be dispersed, and hence the occurrence of rubbing scratches can be suppressed.

In the photosensitive member including the surface layer containing the polymerized product obtained by polymerizing the polymerizable composition containing the compound A, the occurrence of rubbing scratches can be suppressed when ht/hc is 1.5 or more.

Accordingly, it has been found that, when the formulae (1), (2), and (3) are satisfied, a surface layer that achieves both of film strength and film elasticity is obtained, and scratch resistance improves.

The satisfaction of the formulae (1), (2), and (3) can be achieved by selecting a bonding form of the urethane structure and the methacryloyl group for the compound in the polymerizable composition for forming the surface layer. Specifically, the polymerizable composition contains the compound A, and the compound A contains a urethane structure and a methacryloyl group. Further, the compound A preferably has a group represented by the formula (CT-1). When the compound A has the group represented by the formula (CT-1), the compound A may have two methacryloyl groups (—COC(CH₃)═CH₂) for one urethane structure (—O—CO—NH—):

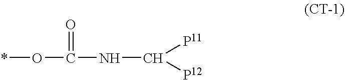

in the formula (CT-1), P¹¹ and P¹² each independently represent a group represented by the following formula (P-1), and * represents a bonding site:

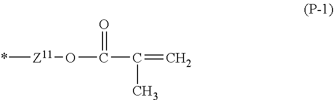

in the formula (P-1), Z¹¹ represents an alkylene group having 1 to 4 carbon atoms, and * represents a bonding site.

When the polymerizable compound has the urethane structure and the methacryloyl group, it is conceived that the distance between the methacryloyl groups, which are polymerizable groups, increases, and the strength of the film tends to decrease. Accordingly, it is preferred that the compound A has a plurality of methacryloyl groups, via a branched structure, adjacent to the urethane structure because a decrease in strength of the film can be prevented.

More specifically, the compound A is preferably represented by the formula (CT-2-1) or the formula (CT-2-2):

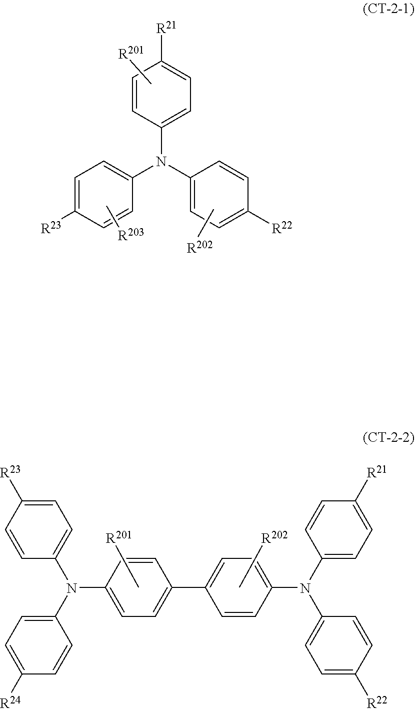

in the formula (CT-2-1) and the formula (CT-2-2), at least one of R²¹ to R²⁴ represents a group represented by the formula (A), and the others each independently represent a hydrogen atom, a methyl group, a group represented by the formula (A), or a group represented by the formula (B), R²⁰¹ to R²⁰³ each represent a hydrogen atom or a methyl group, and it is more preferred that at least one of R²¹ to R²⁴ represent the formula (A), and another thereof represents a group represented by the formula (A) or a group represented by the formula (B):

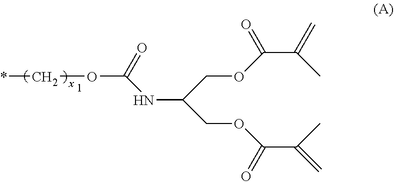

in the formula (A), X₁ represents an integer of from 0 to 3, and * represents a bonding site:

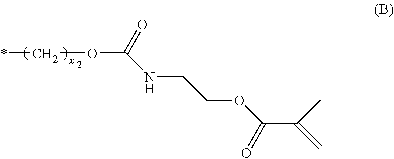

in the formula (B), X₂ represents an integer of from 0 to 3, and * represents a bonding site.

In order to achieve both the strength and elasticity of the film, it is desired that the ratio of the urethane structure to the methacryloyl group in the polymerizable composition for forming the surface layer be adjusted. In the polymerizable composition, the ratio of the urethane structure to the methacryloyl group is preferably adjusted to 0.43 or more and 0.90 or less in terms of molar ratio. When the ratio of the urethane structure to the methacryloyl group is more than 0.90 in terms of molar ratio, the strength of the film becomes insufficient, burrs are generated by abrasion of the surface of the film, and rubbing scratches are liable to occur. When the ratio of the urethane structure to the methacryloyl group is less than 0.43 in terms of molar ratio, the elasticity of the film becomes insufficient, force from the outside cannot be dispersed, and rubbing scratches are liable to occur.

The ratio between the methacryloyl group and the urethane structure in the polymerizable composition for forming the surface layer may be identified by measurement using nuclear magnetic resonance (NMR) analysis or the like.

### <Compound Represented by Formula (CT-2)>

The compounds represented by the formula (CT-2-1) and the formula (CT-2-2) may be used alone or in combination thereof. The formula (CT-2-1) and the formula (CT-2-2) may be collectively referred to as “formula (CT-2).” Specific examples of the compound represented by the formula (CT-2) are given in Table 1 (Table 1-1 to Table 1-4), but the present disclosure is not limited thereto.

TABLE 1-1

| | Skeleton | R²¹ | |
|---|---|---|---|
| CT2-1-1 | 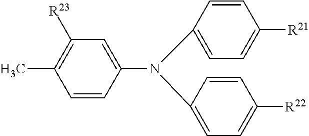 | 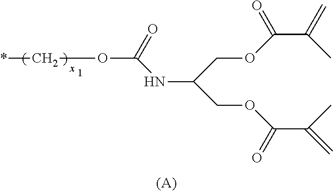 | X₁ = 1 |
| CT2-1-2 | 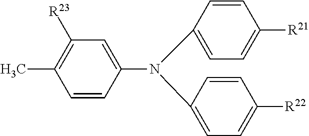 | 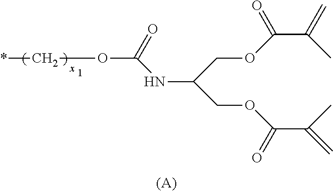 | X₁ = 2 |
| CT2-1-3 | 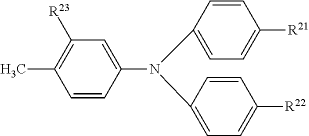 | 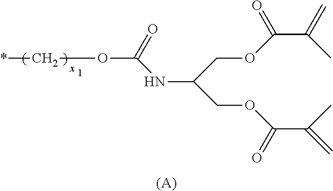 | X₁ = 3 |
| CT2-1-4 | 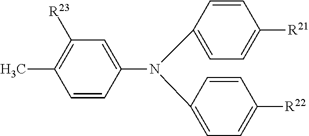 | 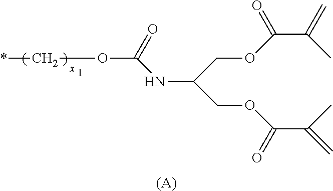 | X₁ = 1 |
| CT2-1-5 | 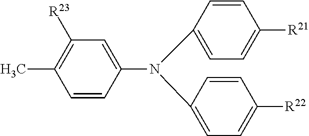 | 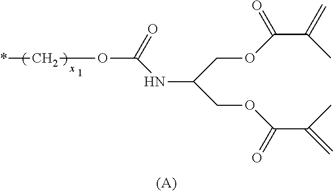 | X₁ = 1 |
| CT2-1-6 | 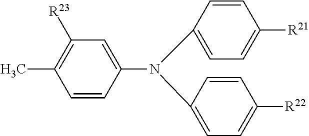 | 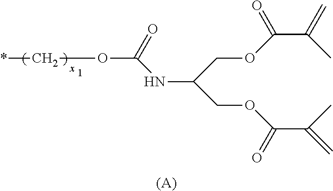 | X₁ = 1 |
| CT2-1-7 | 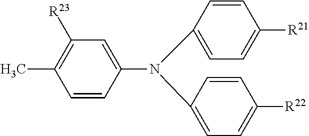 | 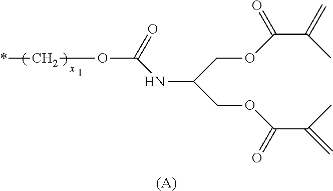 | X₁ = 1 |
| CT2-2-8 | 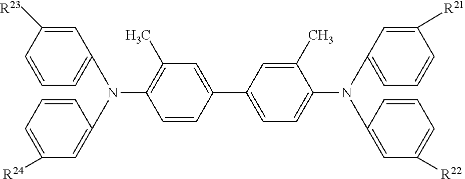 | —H | \ |

TABLE 1-2

| | Skeleton | R²¹ | |
|---|---|---|---|
| CT2- 2-9 | 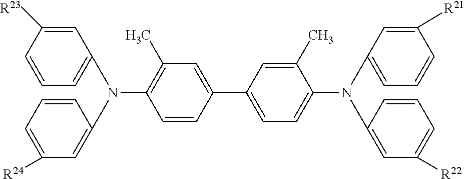 | 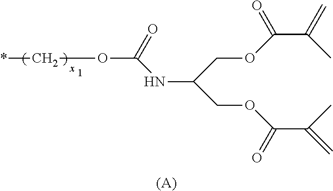 | X₁ = 1 |
| CT2- 2-10 | 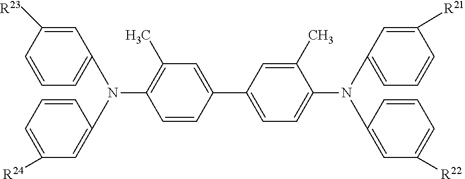 | 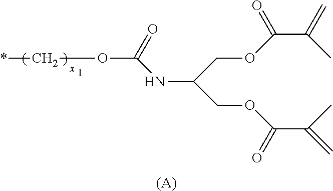 | X₁ = 1 |
| CT2- 2-11 | 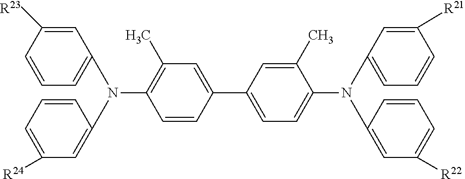 | 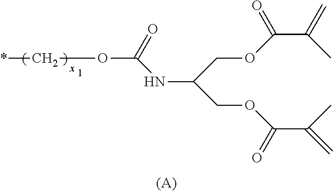 | X₁ = 1 |
| CT2- 2-12 | 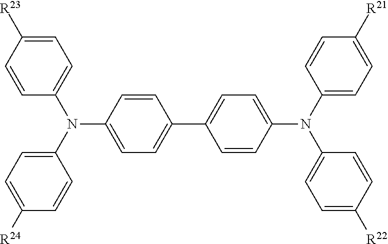 | —H | \ |
| CT2- 2-13 | 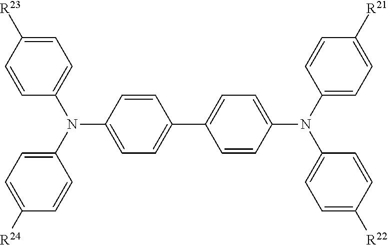 | 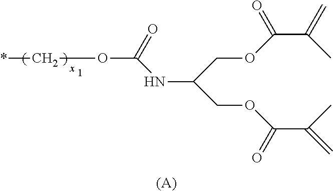 | X₁ = 1 |
| CT2- 2-14 | 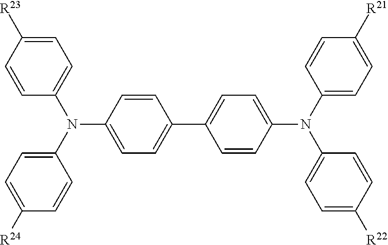 | 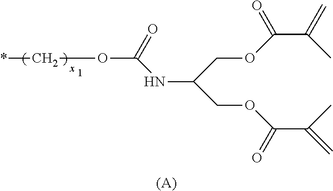 | X₁ = 1 |
| CT2- 2-15 | 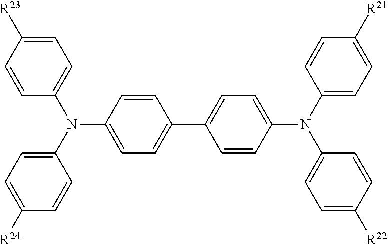 | 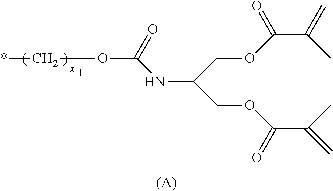 | X₁ = 1 |

TABLE 1-3

| | R²² | | R²³ | | R²⁴ | |
|---|---|---|---|---|---|---|
| CT 2- 1-1 | 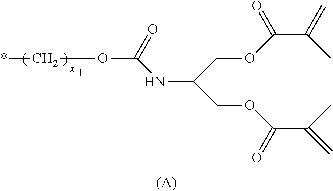 | X₁ = 1 | —CH₃ | \ | \ | \ |
| CT 2- 1-2 | 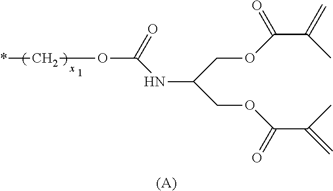 | X₁ = 2 | —CH₃ | \ | \ | \ |
| CT 2- 1-3 | 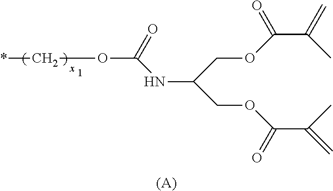 | X₁ = 3 | —CH₃ | \ | \ | \ |
| CT 2- 1-4 | 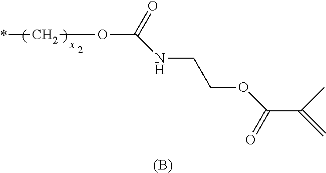 | X₂ = 1 | —CH₃ | \ | \ | \ |
| CT 2- 1-5 | 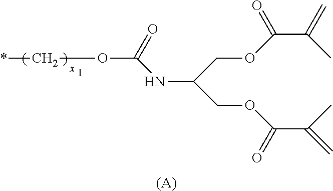 | X₁ = 1 | 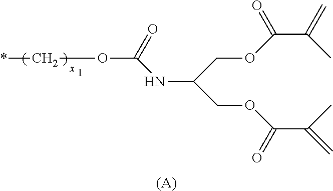 | X₁ = 1 | \ | \ |
| CT 2- 1-6 | 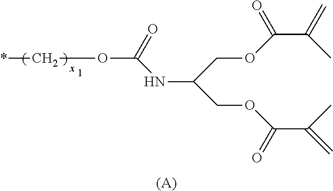 | X₁ = 1 | 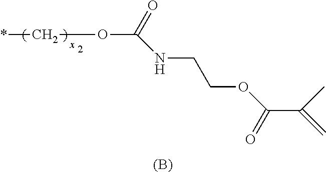 | X₂ = 1 | \ | \ |
| CT 2- 1-7 | 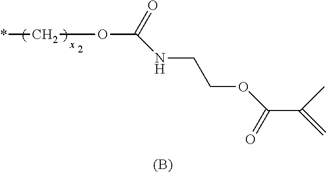 | X₂ = 1 | 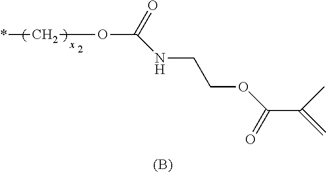 | X₂ = 1 | \ | \ |
| CT 2- 2-8 | 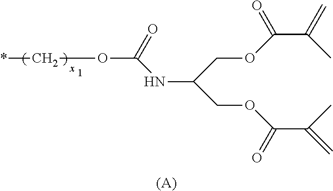 | X₁ = 1 | —H | \ | 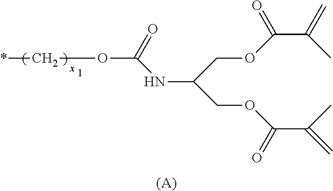 | X₁ = 1 |

TABLE 1-4

| | R²² | | R²³ | | R²⁴ | |
|---|---|---|---|---|---|---|
| CT2- 2-9 | 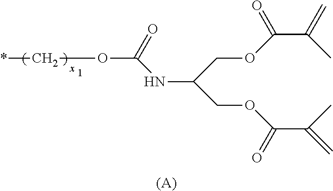 | X₁ = 1 | 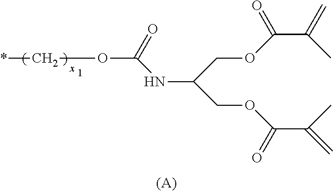 | X₁ = 1 | 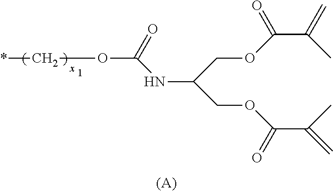 | X₁ = 1 |
| CT2- 2- 10 | 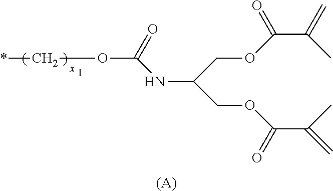 | X₁ = 1 | 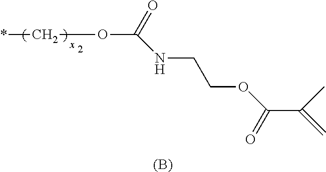 | X₂ = 1 | 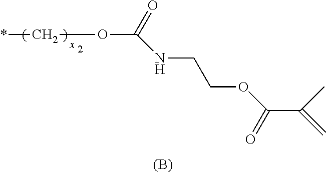 | X₂ = 1 |
| CT2- 2- 11 | 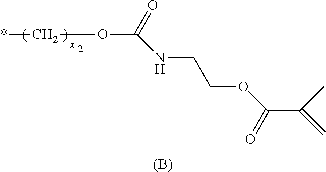 | X₂ = 1 | 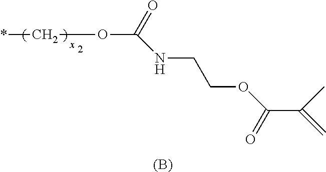 | X₂ = 1 | 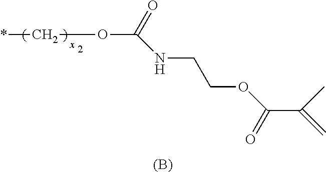 | X₂ = 1 |
| CT2- 2- 12 | 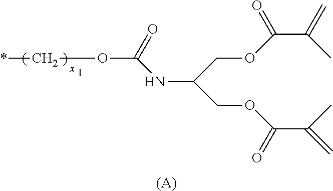 | X₁ = 1 | —H | \ | 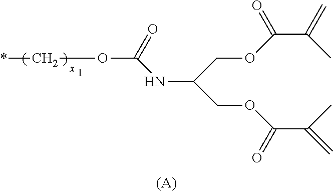 | X₁ = 1 |
| CT2- 2- 13 | 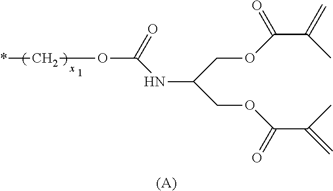 | X₁ = 1 | 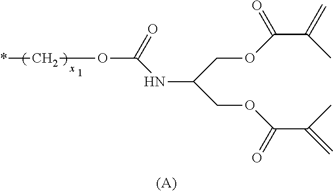 | X₁ = 1 | 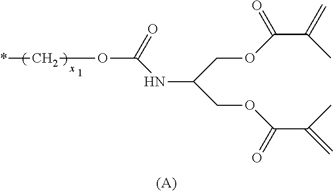 | X₁ = 1 |
| CT2- 2- 14 | 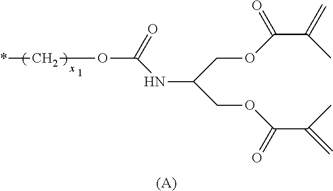 | X₁ = 1 | 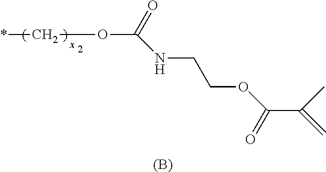 | X₂ = 1 | 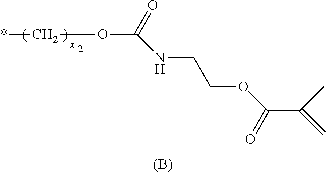 | X₂ = 1 |
| CT2- 2- 15 | 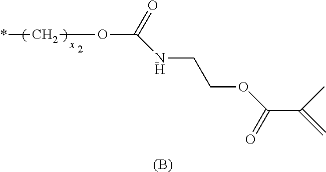 | X₂ = 1 | 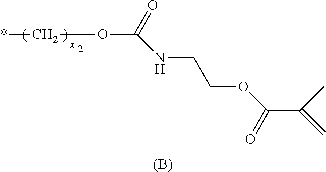 | X₂ = 1 | 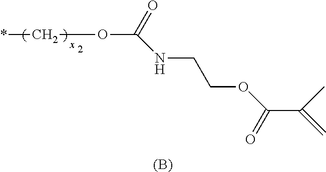 | X₂ = 1 |

### <Measurement of Load-Displacement Curve by Dynamic Nanoindentation Method>

In Examples of the present disclosure, the load-displacement curve of the electrophotographic photosensitive member was measured with Hysitron TI980 TriboIndenter (manufactured by Bruker Japan K.K.) as described below. The electrophotographic photosensitive member was cut into a section of 10 mm×10 mm, and the outermost surface of the cut sample was subjected to the measurement.

The measurement conditions of TI980 are as described below.
Apparatus: TI980 (using nanoDMA transducer and Berkovich indenter)
Measurement temperature and humidity environment: 25° C. and 50%
Frequency: 150 Hz
Load condition: 50 μN
Loading time: 1 second
Holding time: 0.5 second
Unloading time: 1 second

Number of measurement points: Measurement was performed at a total of 25 points of 5 points×5 points at a pitch of 2 μm, and the measured values were averaged.

### <Compounds Represented by Formulae (CT-3) and (CT-4)>

The compound A is preferably a charge-transporting compound. Meanwhile, the polymerizable composition may further contain a non-charge-transporting compound represented by the formula (CT-3) or the following formula (CT-4). The non-charge-transporting compounds may be used alone or in combination thereof.

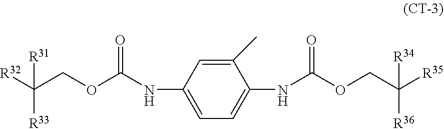

In the formula (CT-3), R³¹ to R³⁶ each independently represent an acryloyl group, a methacryloyl group, a hydrogen atom, or a methyl group.

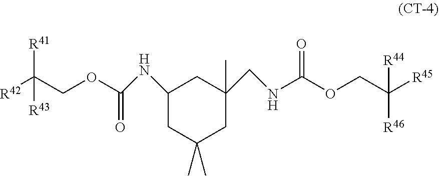

In the formula (CT-4), R⁴¹ to R⁴⁶ each independently represent an acryloyl group, a methacryloyl group, a hydrogen atom, or a methyl group.

As for the ratio of the compound represented by the formula (CT-3) or the formula (CT-4), the ratio of the compound represented by the formula (CT-3) or the formula (CT-4) to the compound A in the polymerizable composition is preferably 0.49 or less in terms of mass ratio, more preferably 0.30 or less in terms of mass ratio. When the ratio is more than 0.49 in terms of mass ratio, the elasticity of the film is lost, and hence rubbing scratches occur.

In addition, when the compound A has the group represented by the formula (CT-1), the ratio of the compound represented by the formula (CT-3) or the formula (CT-4) to the compound A having the group represented by the formula (CT-1) in the polymerizable composition is preferably 0.49 or less in terms of mass ratio, more preferably 0.30 or less in terms of mass ratio. In addition, when the compound A is the compound represented by the formula (CT-2), the ratio of the compound represented by the formula (CT-3) or the formula (CT-4) to the compound A having the group represented by the formula (CT-2) in the polymerizable composition is preferably 0.49 or less in terms of mass ratio, more preferably 0.30 or less in terms of mass ratio.

Specific examples of the compound represented by the formula (CT-3) or the formula (CT-4) are given below, but the present disclosure is not limited thereto.

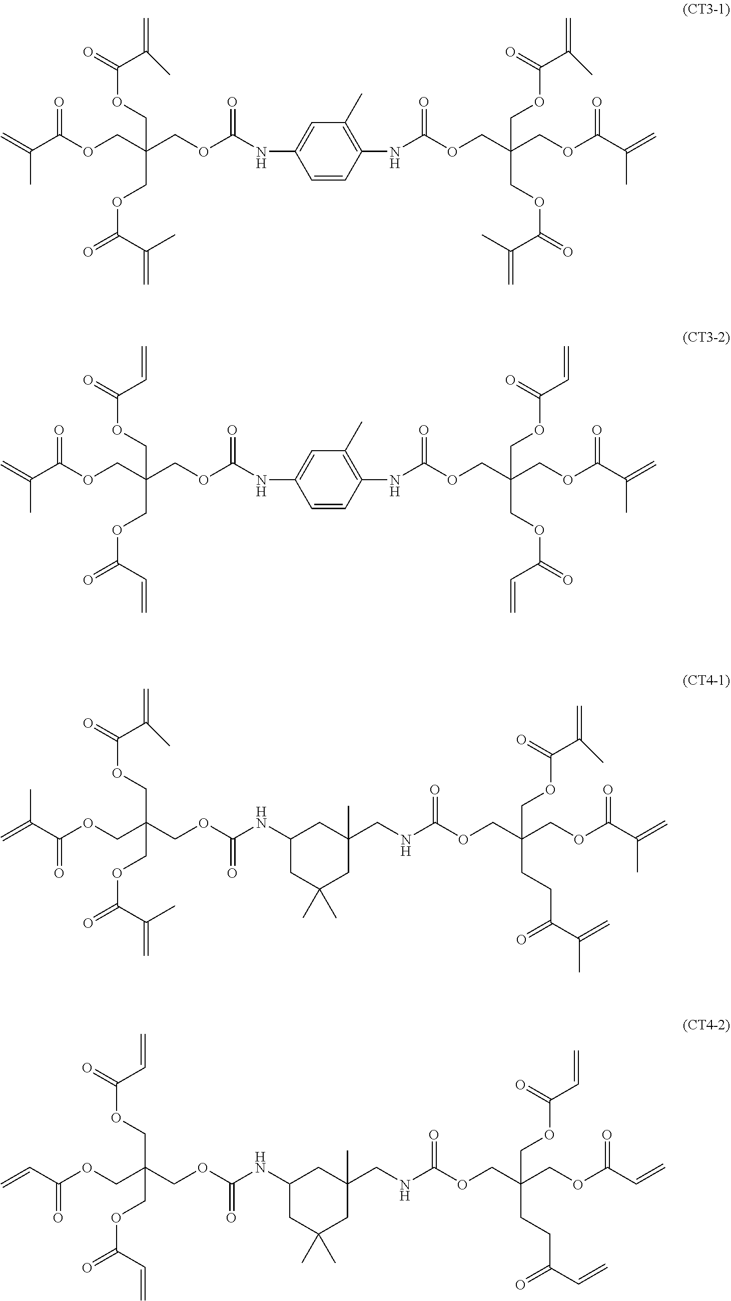

### <Electrophotographic Photosensitive Member>

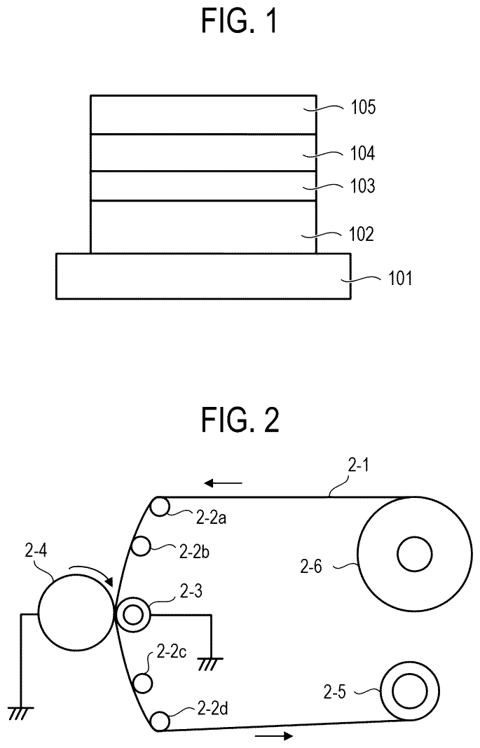

An example of the layer configuration of the electrophotographic photosensitive member of the present disclosure is illustrated in FIG. 1. In FIG. 1, an undercoat layer 102, a charge-generating layer 103, a charge-transporting layer 104, and a protective layer 105 are laminated on a support 101. A photosensitive layer may include a laminate-type photosensitive layer including the charge-generating layer and the charge-transporting layer, or may include a monolayer-type photosensitive layer containing a charge-generating substance and a charge-transporting substance. In the present disclosure, the surface layer is preferably the protective layer 105.

Examples of a method of applying a coating liquid for a surface layer include dip coating, spray coating, inkjet coating, roll coating, die coating, blade coating, curtain coating, wire bar coating, and ring coating. Of those, dip coating is preferred from the viewpoints of efficiency and productivity.

The configuration of the electrophotographic photosensitive member of the present disclosure is described below.

### <Support>

The support of the electrophotographic photosensitive member is preferably a support having electroconductivity (electroconductive support). In addition, examples of the shape of the support include a cylindrical shape, a belt shape, and a sheet shape. Of those, a cylindrical support is preferred. In addition, the surface of the support may be subjected to, for example, electrochemical treatment such as anodization, blast treatment, or cutting treatment.

A metal, a resin, glass, or the like is preferred as a material for the support.

Examples of the metal include aluminum, iron, nickel, copper, gold, stainless steel, and alloys thereof. Of those, an aluminum-made support using aluminum is preferred.

In addition, electroconductivity is preferably imparted to the resin or the glass through treatment involving, for example, mixing or coating the resin or the glass with an electroconductive material.

### <Surface Layer>

The surface layer is a part where the photosensitive member is brought into contact with toner and various members during an electrophotographic process. When the photosensitive member includes a protective layer, the protective layer may serve as the surface layer. When the photosensitive member is free of a protective layer and the photosensitive layer is a laminate-type photosensitive layer, the charge-transporting layer may serve as the surface layer. When the photosensitive member is free of a protective layer and the photosensitive layer is a monolayer-type photosensitive layer, the photosensitive layer may serve as the surface layer. In the present disclosure, the surface layer is preferably the protective layer.

### <Electroconductive Layer>

An electroconductive layer may be arranged on the support. When the electroconductive layer is arranged, flaws and unevenness in the surface of the support can be concealed, and reflection of light on the surface of the support can be controlled.

The electroconductive layer preferably contains electroconductive particles and a resin.

A material for the electroconductive particles is, for example, a metal oxide, a metal, or carbon black.

Examples of the metal oxide include zinc oxide, aluminum oxide, indium oxide, silicon oxide, zirconium oxide, tin oxide, titanium oxide, strontium titanate, magnesium oxide, antimony oxide, and bismuth oxide. Examples of the metal include aluminum, nickel, iron, nichrome, copper, zinc, and silver.

Of those, metal oxide particles are preferably used as the electroconductive particles, and in particular, titanium oxide particles, tin oxide particles, and zinc oxide particles are more preferably used.

When the metal oxide particles are used as the electroconductive particles, the surface of each of the metal oxide particles may be treated with a silane coupling agent or the like, or the metal oxide particles may each be doped with an element, such as phosphorus or aluminum, or an oxide thereof.

In addition, the electroconductive particles may each have a laminated configuration including a core particle and a coating layer coating the particle. Examples of the core particle include titanium oxide particles, barium sulfate particles, and zinc oxide particles. A material for the coating layer is, for example, metal oxide particles such as tin oxide.

In addition, when the metal oxide particles are used as the electroconductive particles, their volume-average particle diameter is preferably 1 nm or more and 500 nm or less, more preferably 3 nm or more and 400 nm or less.

Examples of the resin include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the electroconductive layer may further contain, for example, a silicone oil, resin particles, or a concealing agent such as titanium oxide.

The electroconductive layer may be formed by preparing a coating liquid for an electroconductive layer containing the above-mentioned materials and a solvent, forming a coating film thereof on the support, and drying the coating film. Examples of the solvent to be used in the coating liquid for an electroconductive layer include an alcohol-based solvent, a sulfoxide-based solvent, a ketone-based solvent, an ether-based solvent, an ester-based solvent, and an aromatic hydrocarbon-based solvent. A dispersion method for dispersing the electroconductive particles in the coating liquid for an electroconductive layer is, for example, a method including using a paint shaker, a sand mill, a ball mill, or a liquid collision-type high-speed disperser.

The thickness of the electroconductive layer is preferably 1 μm or more and 50 μm or less, particularly preferably 3 μm or more and 40 μm or less.

### <Undercoat Layer>

In the present disclosure, the undercoat layer may be arranged on the support or the electroconductive layer. The arrangement of the undercoat layer enables an improvement in adhesive function between layers to impart a charge injection-inhibiting function.

The undercoat layer preferably contains a resin. In addition, the undercoat layer may be formed as a cured film by polymerizing a composition containing a monomer having a polymerizable functional group.

Examples of the resin include a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamic acid resin, a polyimide resin, a polyamide imide resin, and a cellulose resin.

Examples of the polymerizable functional group of the monomer having a polymerizable functional group include an isocyanate group, a blocked isocyanate group, a methylol group, an alkylated methylol group, an epoxy group, a metal alkoxide group, a hydroxy group, an amino group, a carboxy group, a thiol group, a carboxylic acid anhydride group, and a carbon-carbon double bond group.

In addition, the undercoat layer may further contain an electron-transporting substance, metal oxide particles, metal particles, an electroconductive polymer, and the like for the purpose of improving electric characteristics. Of those, an electron-transporting substance and metal oxide particles are preferably used.

Examples of the electron-transporting substance include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. An electron-transporting substance having a polymerizable functional group may be used as the electron-transporting substance and copolymerized with the above-mentioned monomer having a polymerizable functional group to form the undercoat layer as a cured film.

Examples of the metal oxide particles include particles of indium tin oxide, tin oxide, indium oxide, titanium oxide, strontium titanate, zinc oxide, and aluminum oxide. Particles of silicon dioxide may also be used. Examples of the metal particles include particles of gold, silver, and aluminum.

The metal oxide particles in the undercoat layer may be subjected to surface treatment with a surface treatment agent such as a silane coupling agent before use.

A general method is used as a method of subjecting the metal oxide particles to the surface treatment. Examples thereof include a dry method and a wet method.

The dry method involves, while stirring the metal oxide particles in a mixer capable of high-speed stirring such as a Henschel mixer, adding an alcoholic aqueous solution, organic solvent solution, or aqueous solution containing the surface treatment agent, uniformly dispersing the mixture, and then drying the dispersion.

In addition, the wet method involves stirring the metal oxide particles and the surface treatment agent in a solvent, or dispersing the metal oxide particles and the surface treatment agent in a solvent with a sand mill or the like using glass beads or the like. After the dispersion, the solvent is removed by filtration or evaporation under reduced pressure. After the removal of the solvent, it is preferred to further perform baking at 100° C. or more.

The undercoat layer may further contain an additive, and for example, may contain a known material, such as: metal particles such as aluminum particles; electroconductive particles such as carbon black; a charge-transporting substance; a metal chelate compound; or an organometallic compound.

The undercoat layer may be formed by preparing a coating liquid for an undercoat layer containing the above-mentioned materials and a solvent, forming a coating film thereof on the support or the electroconductive layer, and drying and/or curing the coating film.

Examples of the solvent to be used in the coating liquid for an undercoat layer include organic solvents, such as an alcohol, a sulfoxide, a ketone, an ether, an ester, a halogenated aliphatic hydrocarbon, and an aromatic compound. In the present disclosure, alcohol-based and ketone-based solvents are preferably used.

A dispersion method for preparing the coating liquid for an undercoat layer is, for example, a method including using a homogenizer, an ultrasonic disperser, a ball mill, a sand mill, a roll mill, a vibration mill, an attritor, or a liquid collision-type high-speed disperser.

The thickness of the undercoat layer is preferably 0.1 μm or more, more preferably 0.2 μm or more, particularly preferably 0.3 μm or more. In addition, the thickness of the undercoat layer is preferably 50 μm or less, more preferably 40 μm or less, more preferably 30 μm or less, more preferably 10 μm or less, particularly preferably 5 μm or less.

### <Photosensitive Layer>

The photosensitive layers of the electrophotographic photosensitive member are mainly classified into (1) a laminate-type photosensitive layer and (2) a monolayer-type photosensitive layer. (1) The laminate-type photosensitive layer is a photosensitive layer including a charge-generating layer containing a charge-generating substance and a charge-transporting layer containing a charge-transporting substance. (2) The monolayer-type photosensitive layer is a photosensitive layer containing both of a charge-generating substance and a charge-transporting substance.

### (1) Laminate-type Photosensitive Layer

The laminate-type photosensitive layer includes the charge-generating layer and the charge-transporting layer.

### (1-1) Charge-Generating Layer

The charge-generating layer preferably contains the charge-generating substance and a resin.

Examples of the charge-generating substance include azo pigments, perylene pigments, polycyclic quinone pigments, indigo pigments, and phthalocyanine pigments. Of those, azo pigments and phthalocyanine pigments are preferred. Of the phthalocyanine pigments, an oxytitanium phthalocyanine pigment, a chlorogallium phthalocyanine pigment, and a hydroxygallium phthalocyanine pigment are preferred.

The content of the charge-generating substance in the charge-generating layer is preferably 40% by mass or more and 85% by mass or less, more preferably 60% by mass or more and 80% by mass or less with respect to the total mass of the charge-generating layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Of those, a polyvinyl butyral resin is more preferred.

In addition, the charge-generating layer may further contain an additive, such as an antioxidant or a UV absorber. Specific examples thereof include a hindered phenol compound, a hindered amine compound, a sulfur compound, a phosphorus compound, and a benzophenone compound.

The charge-generating layer may be formed by preparing a coating liquid for a charge-generating layer containing the above-mentioned materials and a solvent, forming a coating film thereof on the undercoat layer, and drying the coating film. Examples of the solvent to be used in the coating liquid include an alcohol-based solvent, a sulfoxide-based solvent, a ketone-based solvent, an ether-based solvent, an ester-based solvent, and an aromatic hydrocarbon-based solvent.

The thickness of the charge-generating layer is preferably 0.1 μm or more and 1 μm or less, more preferably 0.15 μm or more and 0.4 μm or less.

### (1-2) Charge-Transporting Layer

The charge-transporting layer preferably contains the charge-transporting substance and a binder material.

Examples of the charge-transporting substance include a polycyclic aromatic compound, a heterocyclic compound, a hydrazone compound, a styryl compound, an enamine compound, a triarylamine compound, and a resin having a group derived from each of those substances. Of those, a triarylamine compound is preferred.

The content of the charge-transporting substance in the charge-transporting layer is preferably 25% by mass or more and 70% by mass or less, more preferably 30% by mass or more and 55% by mass or less with respect to the total mass of the charge-transporting layer.

A thermoplastic resin (hereinafter also referred to as “resin”) is used as the binder material.

Examples of the thermoplastic resin include a polyester resin, a polycarbonate resin, an acrylic resin, and a polystyrene resin. Of those, a polycarbonate resin and a polyester resin are preferred. The polyester resin is particularly preferably a polyarylate resin.

A content ratio (mass ratio) between the charge-transporting substance and the resin is preferably from 4:10 to 20:10, more preferably from 5:10 to 12:10.

In addition, the charge-transporting layer may contain an additive, such as an antioxidant, a UV absorber, a plasticizer, or a leveling agent. Specific examples thereof include a hindered phenol compound, a hindered amine compound, a sulfur compound, a phosphorus compound, a benzophenone compound, a siloxane-modified resin, a silicone oil, polystyrene resin particles, polyethylene resin particles, and boron nitride particles.

The charge-transporting layer may be formed by preparing a coating liquid for a charge-transporting layer containing the above-mentioned materials and a solvent, forming a coating film thereof on the charge-generating layer, and drying the coating film. Examples of the solvent to be used in the coating liquid include an alcohol-based solvent, a ketone-based solvent, an ether-based solvent, an ester-based solvent, and an aromatic hydrocarbon-based solvent. Of those solvents, an ether-based solvent or an aromatic hydrocarbon-based solvent is preferred.

The thickness of the charge-transporting layer is preferably 5 μm or more and 50 μm or less, more preferably 8 μm or more and 40 μm or less, particularly preferably 10 μm or more and 30 μm or less.

### (2) Monolayer-type Photosensitive Layer

The monolayer-type photosensitive layer may be formed by preparing a coating liquid for a photosensitive layer containing the charge-generating substance, the charge-transporting substance, a resin, and a solvent, forming a coating film thereof on the undercoat layer, and drying the coating film. Examples of the charge-generating substance, the charge-transporting substance, and the resin are the same as those of the materials in the section “(1) Laminate-type Photosensitive Layer.”

### <Protective Layer>

The photosensitive member may include a protective layer. When the photosensitive member includes a protective layer, the protective layer serves as the surface layer.

The protective layer may contain an additive, such as an antioxidant, a UV absorber, a plasticizer, or a leveling agent. Specific examples thereof include a hindered phenol compound, a hindered amine compound, a phosphorus compound, a benzophenone compound, a siloxane-modified resin, a silicone oil, and a silicone compound. An example of the silicone compound may be a silicone compound having an acryloyloxy group or a methacryloyloxy group such as a silicone-modified acrylic resin.

The protective layer may be formed by preparing a coating liquid for a protective layer containing the above-mentioned materials and a solvent, forming a coating film thereof on the photosensitive layer, and drying and/or curing the coating film. Examples of the solvent to be used in the coating liquid include an alcohol-based solvent, a ketone-based solvent, an ether-based solvent, a sulfoxide-based solvent, an ester-based solvent, and an aromatic hydrocarbon-based solvent.

The thickness of the protective layer is preferably 0.5 μm or more and 10 μm or less, more preferably 1 μm or more and 7 μm or less.

### <Surface Processing of Electrophotographic Photosensitive Member>

In the present disclosure, surface processing may be performed on the electrophotographic photosensitive member. When the surface processing is performed, the behavior of a cleaning unit (cleaning blade) to be brought into contact with the electrophotographic photosensitive member can be further stabilized.

### <Polishing Apparatus>

FIG. 2 is an illustration of an example of a polishing apparatus for the electrophotographic photosensitive member of the present disclosure.

FIG. 2 is an illustration of an apparatus for polishing a cylindrical electrophotographic photosensitive member using a polishing sheet. In FIG. 2, a polishing sheet 2-1 is wound around a hollow shaft 2-6, and a motor (not shown) is arranged so that tension is applied to the polishing sheet 2-1 in a direction opposite to a direction in which the polishing sheet 2-1 is fed to the shaft 2-6. The polishing sheet 2-1 is fed in the direction indicated by the arrow, and passes through a backup roller 2-3 via guide rollers 2-2a and 2-2b, and the polishing sheet 2-1 after polishing is wound around a winding unit 2-5 by a motor (not shown) via guide rollers 2-2c and 2-2d. The polishing is performed by constantly bringing the polishing sheet 2-1 into pressure contact with an object (electrophotographic photosensitive member before polishing) 2-4 to be processed. The polishing sheet 2-1 often has an insulating property, and hence it is preferred to use a member that is grounded or has electroconductivity at a portion where the polishing sheet 2-1 is brought into contact.

The feed speed of the polishing sheet 2-1 preferably falls within the range of from 10 mm/min to 1,000 mm/min. When a feed amount is small, adhesion of a binder resin to the surface of the polishing sheet 2-1 may occur, and as a result, deep scratches may be formed on the surface of the object 2-4 to be processed.

The object 2-4 to be processed is placed at a position facing the backup roller 2-3 via the polishing sheet 2-1. The backup roller 2-3 is preferably an elastic body from the viewpoint of improving the uniformity of the surface roughness of the object 2-4 to be processed. At this time, the object 2-4 to be processed and the backup roller 2-3 are pressed against each other via the polishing sheet 2-1 at a desired set value for a predetermined time period, and the surface of the object 2-4 to be processed is polished. The rotation direction of the object 2-4 to be processed may be the same as the direction in which the polishing sheet 2-1 is fed, or may be opposite thereto. In addition, the rotation direction may be changed during polishing.

The pressing pressure of the backup roller 2-3 against the object 2-4 to be processed is preferably from 0.005 N/m² to 15 N/m² depending on the hardness of the backup roller 2-3 and the polishing time.

The surface roughness of the electrophotographic photosensitive member may be adjusted by appropriately selecting the feed speed of the polishing sheet 2-1, the pressing pressure of the backup roller 2-3, the abrasive grain type of the polishing sheet, the thickness of the binder resin of the polishing sheet, the thickness of the substrate, or the like.

### <Measurement of Maximum Height Rmax in JIS B 0601:1982>

The surface roughness of the electrophotographic photosensitive member may be measured by a known unit. For example, the following unit is given.

A surface roughness meter such as a surface roughness measuring instrument SURFCORDER SE3500 manufactured by Kosaka Laboratory Ltd.

In the present disclosure, out of the indices of a surface roughness, the maximum height Rmax in JIS B 0601:1982 specified by Japanese Industrial Standards (JIS) was used as an index of a roughness.

### <Process Cartridge and Electrophotographic Apparatus>

The electrophotographic photosensitive member of the present disclosure may be one constituent for a process cartridge or an electrophotographic apparatus. The process cartridge has features of integrally supporting the electrophotographic photosensitive member described in the foregoing, and at least one unit selected from the group consisting of: a charging unit; a developing unit; a transfer unit; and a cleaning unit, and being detachably attachable to the main body of an electrophotographic apparatus. In addition, the electrophotographic apparatus has a feature of including the electrophotographic photosensitive member described in the foregoing, a charging unit, an exposing unit, a developing unit, and a transfer unit.

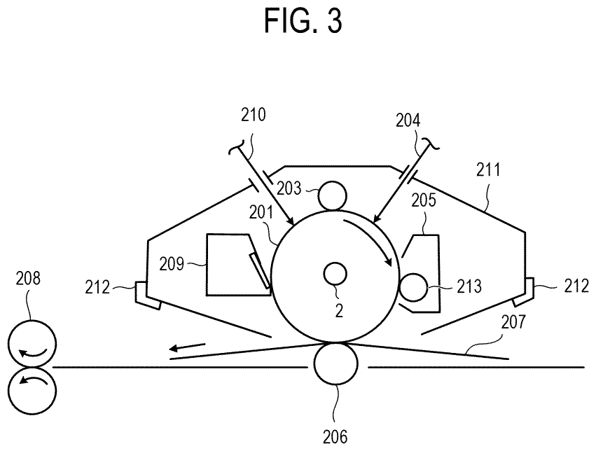

An example of the schematic configuration of an electrophotographic apparatus including a process cartridge including the electrophotographic photosensitive member of the present disclosure is illustrated in FIG. 3.

An electrophotographic photosensitive member 201 of a cylindrical shape (drum shape) is driven to rotate about a shaft 202 in a direction indicated by the arrow at a predetermined peripheral speed (process speed). The surface of the electrophotographic photosensitive member 201 is charged to a predetermined positive or negative potential by a charging unit 203 in the rotational process. In FIG. 3, a roller charging system based on a roller-type charging member is illustrated, but a charging system, such as a corona charging system, a proximity charging system, or an injection charging system, may be adopted. The charged surface of the electrophotographic photosensitive member 201 is irradiated with exposure light 204 from an exposing unit (not shown), and thus an electrostatic latent image corresponding to target image information is formed thereon. The exposure light 204 is light whose intensity has been modulated in correspondence with a time-series electric digital image signal of the target image information, and is emitted, for example, from an image exposing unit, such as slit exposure or laser beam scanning exposure. The electrostatic latent image formed on the surface of the electrophotographic photosensitive member 201 is developed (normal development or reversal development) with toner on a developing member 213 stored in a developing unit 205 to form a toner image on the surface of the electrophotographic photosensitive member 201. The toner image formed on the surface of the electrophotographic photosensitive member 201 is transferred by a transfer unit 206 onto a transfer material 207. At this time, a bias voltage opposite in polarity to charge that the toner has is applied from a bias power source (not shown) to the transfer unit 206. In addition, when the transfer material 207 is paper, the transfer material 207 is taken out of a sheet feeding portion (not shown) and fed to a space between the electrophotographic photosensitive member 201 and the transfer unit 206 in synchronization with the rotation of the electrophotographic photosensitive member 201. The transfer material 207 onto which the toner image has been transferred from the electrophotographic photosensitive member 201 is separated from the surface of the electrophotographic photosensitive member 201, is conveyed to a fixing unit 208, and is subjected to treatment for fixing the toner image to be printed out as an image-formed product (a print or a copy) to the outside of the electrophotographic apparatus. The electrophotographic apparatus may include a cleaning unit 209 for removing a deposit such as the toner remaining on the surface of the electrophotographic photosensitive member 201 after the transfer. In addition, a so-called cleaner-less system that removes the deposit with the developing unit or the like without separate arrangement of the cleaning unit may be used. A plurality of constituents selected from the electrophotographic photosensitive member 201, the charging unit 203, the developing unit 205, the cleaning unit 209, and the like may be stored in a container and integrally supported to form a process cartridge. In addition, the process cartridge may be configured to be detachably attachable to the main body of the electrophotographic apparatus. For example, the following configuration is adopted. At least one selected from the charging unit 203, the developing unit 205, and the cleaning unit 209 is integrally supported with the electrophotographic photosensitive member 201 to form a cartridge. The cartridge may be used as a process cartridge 211 to be detachably attachable to the main body of the electrophotographic apparatus with a guiding unit 212 such as a rail of the main body of the electrophotographic apparatus. The electrophotographic apparatus may include a charge-eliminating mechanism for subjecting the surface of the electrophotographic photosensitive member 201 to charge-eliminating treatment with pre-exposure light 210 from a pre-exposing unit (not shown). In addition, the guiding unit 212 such as the rail may be arranged for detachably attaching the process cartridge 211 onto the main body of the electrophotographic apparatus. The electrophotographic apparatus of the present disclosure has a feature of including the electrophotographic photosensitive member 201, and the charging unit 203, the exposing unit, the developing unit 205, and the transfer unit 206.

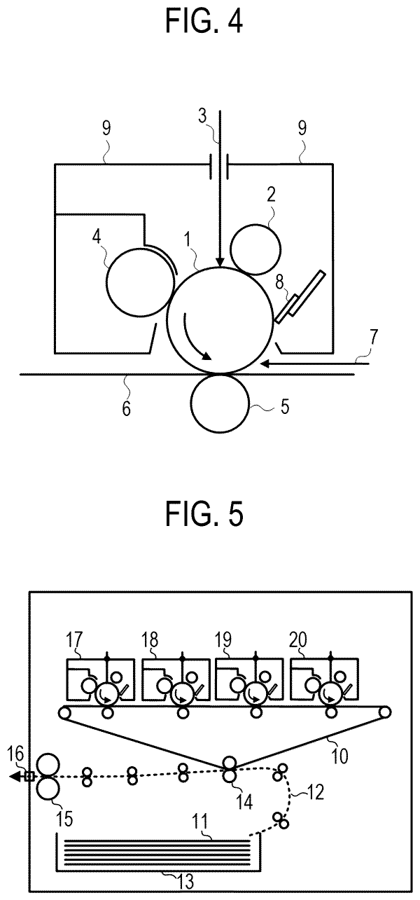

In addition, an example of the schematic configuration of a process cartridge including the electrophotographic photosensitive member of the present disclosure is illustrated in FIG. 4, and an example of the schematic configuration of an electrophotographic apparatus including the process cartridge of FIG. 4 is illustrated in FIG. 5.

In FIG. 4, a cylindrical electrophotographic photosensitive member 1 is driven to rotate at a predetermined peripheral speed in a direction indicated by the arrow. The circumferential surface of the electrophotographic photosensitive member 1 that is driven to rotate is uniformly charged to a positive or negative predetermined potential by a charging unit 2. Then, the charged circumferential surface of the electrophotographic photosensitive member 1 receives exposure light (image exposure light) 3 emitted from an exposing unit (not shown), such as slit exposure light or laser beam scanning exposure light. Thus, an electrostatic latent image corresponding to an intended image is sequentially formed on the circumferential surface of the electrophotographic photosensitive member 1. Any one of a voltage in which an AC component is superimposed on a DC component or a voltage formed of only a DC component may be used as a voltage to be applied to the charging unit (e.g., a charging roller) 2.

The electrostatic latent image formed on the circumferential surface of the electrophotographic photosensitive member 1 is developed with toner in a developer of a developing unit 4 to form a toner image. Then, the toner image formed and borne on the circumferential surface of the electrophotographic photosensitive member 1 is sequentially transferred onto a transfer material (e.g., paper or an intermediate transfer member) 6 with a transfer bias from a transfer unit (e.g., a transfer roller) 5. The transfer material 6 is fed in synchronization with the rotation of the electrophotographic photosensitive member 1.

The surface of the electrophotographic photosensitive member 1 after the transfer of the toner image is subjected to charge-eliminating treatment with pre-exposure light 7 from a pre-exposing unit (not shown). After that, the surface is cleaned by removal of transfer residual toner with a cleaning unit 8. Then, the electrophotographic photosensitive member 1 is repeatedly used in image formation. The treatment by the pre-exposing unit may be performed before or after a cleaning step, and the pre-exposing unit is not necessarily required.

The electrophotographic photosensitive member 1 may be mounted on an electrophotographic apparatus, such as a copying machine or a laser beam printer. In addition, a process cartridge 9 configured to integrally support a plurality of constituent elements, such as the electrophotographic photosensitive member 1, the charging unit 2, the developing unit 4, and the cleaning unit 8, accommodated in a container may be configured to be detachably attachable to the main body of the electrophotographic apparatus. In FIG. 4, the electrophotographic photosensitive member 1, the charging unit 2, the developing unit 4, and the cleaning unit 8 are integrally supported to form the process cartridge 9 that is detachably attachable to the main body of the electrophotographic apparatus.

Next, an electrophotographic apparatus including the electrophotographic photosensitive member of the present disclosure is described.

An example of the configuration of the electrophotographic apparatus of the present disclosure is illustrated in FIG. 5. A process cartridge 17 for a yellow color, a process cartridge 18 for a magenta color, a process cartridge 19 for a cyan color, and a process cartridge 20 for a black color, corresponding to a yellow color, a magenta color, a cyan color, and a black color, respectively, are arranged side by side along an intermediate transfer member 10. The diameter and constituent materials of the electrophotographic photosensitive member, a developer, a charging system, and other units are not necessarily required to be the same for each color.

When an image forming operation is started, a toner image of each color is sequentially superimposed on the intermediate transfer member 10 in accordance with the above-mentioned image forming process. In parallel, a transfer sheet 11 is sent from a sheet feeding tray 13 through a sheet feeding path 12 and fed to a secondary transfer unit 14 in synchronization with the timing of the rotation operation of the intermediate transfer member. A toner image on the intermediate transfer member 10 is transferred onto the transfer sheet 11 with a transfer bias from the secondary transfer unit 14. The toner image transferred onto the transfer sheet 11 is conveyed along the sheet feeding path 12 and fixed onto the transfer sheet by a fixing unit 15. Then, the transfer sheet 11 is delivered from a sheet delivery portion 16.

The electrophotographic photosensitive member of the present disclosure may be used in a laser beam printer, an LED printer, a copying machine, a facsimile, a multifunctional peripheral thereof, and the like.

### <Production Method>

The present disclosure provides, as a further embodiment, a method of producing an electrophotographic photosensitive member, the method including a polymerization step of forming a coating film using a coating liquid for a surface layer containing a compound having a group represented by the formula (CT-1), and polymerizing the polymerizable compound in the coating film to form a surface layer. The polymerization step includes polymerizing the compound by irradiation with an electron beam.

According to one aspect of the present disclosure, an electrophotographic photosensitive member excellent in scratch resistance is provided.

### EXAMPLES

The present disclosure is described in more detail below by way of Examples and Comparative Examples, but is not limited thereto. In the description of Examples below, the term “part(s)” means “part(s) by mass” unless otherwise stated.

<Synthesis of Compound represented by Formula (CT-2)>

The compound represented by the formula (CT-2) in the present disclosure may be synthesized by using, for example, a synthesis method described in US Patent Publication No. 2014/0186756.

### Example 1-1

### (Support)

A product obtained by cutting a cylindrical aluminum cylinder (JIS-A3003, aluminum alloy, outer diameter: 30 mm, length: 357.5 mm, wall thickness: 0.7 mm) was used as a support (electroconductive support). The support was subjected to ultrasonic cleaning in a cleaning liquid obtained by incorporating a detergent (product name: CHEMICOL CT, manufactured by Tokiwa Chemical Industries Co., Ltd.) into pure water, and subsequently, the cleaning liquid was washed off. After that, the cleaned product was further subjected to ultrasonic cleaning in pure water to be subjected to degreasing treatment. The resultant was used as a support.

### (Undercoat Layer 1)

The undercoat layer 1 includes the following two layers: an electroconductive layer; and a nylon resin layer. First, the electroconductive layer was formed as described below. 60 Parts by mass of TiO₂ particles coated with oxygen-deficient SnO₂ serving as electroconductive particles, 36.5 parts by mass of a phenol resin serving as a binder resin, and 20 parts by mass of methoxypropanol serving as a solvent were dispersed for 1 hour in a horizontal sand mill disperser using glass beads each having a diameter of 1 mm to prepare a dispersion liquid. In this case, the TiO₂ particles coated with oxygen-deficient SnO₂ serving as the electroconductive particles have a powder resistivity of 100 Ω·cm and a SnO₂ coating ratio (mass ratio) of 40%. In addition, the phenol resin is available under the product name “Plyophen J-325” from DIC Corporation, and has a resin solid content of 60%, 18 Kilograms of glass beads were internally added to the horizontal sand mill, and the number of revolutions of a dispersion disc during dispersion was set to 900 rpm.

The average particle diameter of the TiO₂ particles coated with oxygen-deficient SnO₂ in the dispersion liquid was 0.36 μm. 1.5 Parts by mass of silicone resin particles serving as a surface roughening material and 0.001 part by mass of a silicone oil serving as a leveling agent were added to the dispersion liquid, and the mixture was stirred to prepare a coating liquid for an electroconductive layer. In this case, the silicone resin particles are available under the product name “Tospearl (trademark) 120” from Momentive Performance Materials Japan LLC, and have an average particle diameter of 2 μm. In addition, the silicone oil is available under the product name “SH28PA” from Dow Toray Co., Ltd.

The coating liquid for an electroconductive layer was applied onto the support by dip coating, and the resultant was dried and thermally cured at 150° C. for 30 minutes to form an electroconductive layer having a thickness of 18 μm. The nylon resin layer was formed as described below. A solution prepared by dissolving 40 parts by mass of a methoxymethylated nylon 6 resin (product name: Toresin EF-30T, manufactured by Nagase ChemteX Corporation) in a mixed liquid containing 400 parts by mass of methanol and 200 parts by mass of butanol was applied onto the above-mentioned electroconductive layer by dip coating, and the resultant was heated and dried for 30 minutes in a hot air dryer adjusted to 100° C. to cure the coating film of the solution, to thereby form a nylon resin layer having a thickness of 0.5 μm. Thus, the undercoat layer 1 was formed.

### (Charge-Generating Layer)

4 Parts of a hydroxygallium phthalocyanine crystal (charge-generating substance) in a crystal form having strong peaks at Bragg angles 2θ±0.2° of 7.4° and 28.1° in CuKα characteristic X-ray diffraction, and 0.04 part of a compound represented by the following formula (E) were added to a liquid prepared by dissolving 2 parts of polyvinyl butyral (product name: S-LEC BX-1, manufactured by Sekisui Chemical Co., Ltd.) in 100 parts of cyclohexanone. After that, the mixture was subjected to dispersion treatment with a sand mill using glass beads each having a diameter of 1 mm for 1 hour under an atmosphere of 23±3° C. After the dispersion treatment, 100 parts of ethyl acetate was added to prepare a coating liquid for a charge-generating layer.

The coating liquid for a charge-generating layer was applied onto the undercoat layer by dip coating, and the resultant coating film was dried at 90° C. for 10 minutes to form a charge-generating layer having a thickness of 0.15 μm.

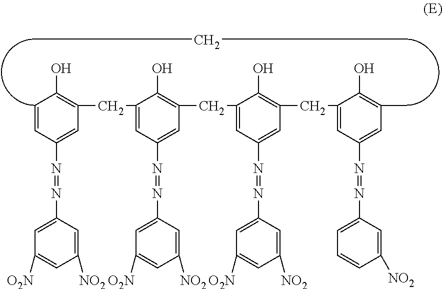

### (Charge-Transporting Layer)

60 Parts of a compound represented by the following formula (F), 30 parts of a compound represented by the following formula (G), 10 parts of a compound represented by the following formula (H), 100 parts of a bisphenol Z-type polycarbonate resin (product name: Iupilon Z400, manufactured by Mitsubishi Engineering-Plastics Corporation), and 0.2 part of a polycarbonate having a structural unit represented by the following formula (I) (viscosity average molecular weight Mv: 20,000) were dissolved in a mixed solvent containing 272 parts of o-xylene, 256 parts of methyl benzoate, and 272 parts of dimethoxymethane to prepare a coating liquid for a charge-transporting layer.

The coating liquid for a charge-transporting layer was applied onto the above-mentioned charge-generating layer by dip coating to form a coating film, and the resultant coating film was dried at 115° C. for 50 minutes to form a charge-transporting layer having a thickness of 18 μm.

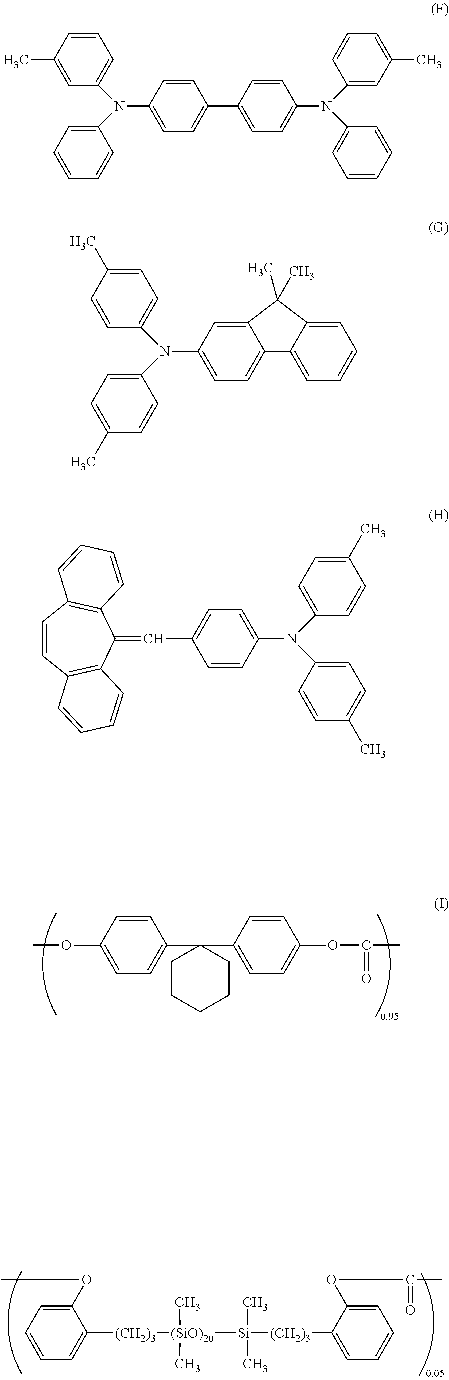

In the formula (I), 0.95 and 0.05 are molar ratios (copolymerization ratios) of the two structural units.

### (Protective Layer)

Next, 60 parts of a compound A represented by the following formula (CT5-1) was dissolved in 70 parts of n-propanol. Further, 70 parts of 1,1,2,2,3,3,4-heptafluorocyclopentane (product name: ZEORORA H, manufactured by Zeon Corporation) was added to the solution, and the materials were mixed. Further, 3 parts of a silicone-modified acrylic resin solution (product name: SYMAC US-270, manufactured by Toagosei Co., Ltd.) was added to prepare a coating liquid for a protective layer. After that, the coating liquid was filtered with a polyflon filter (product name: PF-040, manufactured by Advantec Toyo Kaisha, Ltd.) to prepare a coating liquid for a protective layer.

The coating liquid for a protective layer was applied onto the charge-transporting layer by dip coating to form a coating film, and the resultant coating film was dried at 40° C. for 5 minutes. After the drying, the coating film was irradiated with an electron beam for 4.8 seconds under the conditions of an acceleration voltage of 57 kV and an absorbed dose of 15 kGy under a nitrogen atmosphere. After that, heating treatment was performed for 15 seconds under the condition that the temperature of the coating film became 135° C. under a nitrogen atmosphere. An oxygen concentration in a time period from the electron beam irradiation to the heating treatment for 15 seconds was 15 ppm or less. Next, natural cooling was performed in the air until the temperature of the coating film became 25° C. After that, heating treatment was performed for 1 hour under the condition that the temperature of the coating film became 105° C. to form a surface layer (protective layer) having a thickness of 5 μm.

Thus, an electrophotographic photosensitive member before surface polishing including a support and a surface layer was produced.

The measurement results of the produced protective layer by the dynamic nanoindentation method were as follows: W1 was 30 μN, the value of (W1-W2)/W1 was 0.09, and the value of ht/hc was 1.5.

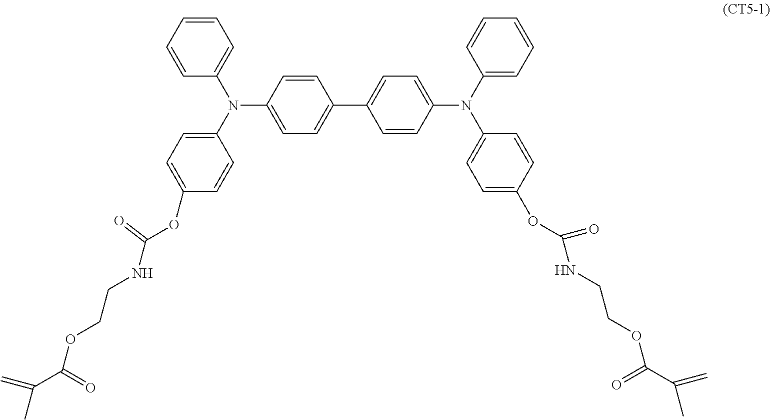 [SMILES: C=C(C)C(=O)OCCNC(=O)Oc1ccc(N(c2ccccc2)c2ccc(-c3ccc(N(c4ccccc4)c4ccc(OC(=O)NCCOC(=O)C(=C)C)cc4)cc3)cc2)cc1]

### Example 2-1

In the production of the photosensitive member of [Example 1-1], the undercoat layer 1 was changed to the following undercoat layer 2, the charge-generating layer, the charge-transporting layer, and the protective layer of [Example 1-1] were formed thereon, and then surface processing was added. Thus, a photosensitive member of Example 2-1 was produced.

### (Undercoat Layer 2)

100 Parts of zinc oxide particles (specific surface area: 19 m²/g, powder resistance: 4.7×10⁶ Ω·cm) were stirred and mixed with 500 parts of toluene, and 0.8 part of a silane coupling agent (compound name: N-2-(aminoethyl)-3-aminopropylmethyldimethoxysilane, product name: KBM-602, manufactured by Shin-Etsu Chemical Co., Ltd.) was added to the mixture, followed by stirring for 6 hours. After that, toluene was evaporated under reduced pressure, and the residue was heated and dried at 130° C. for 6 hours to provide surface-treated zinc oxide particles A.

Subsequently, 15 parts of butyral (product name: BM-1, manufactured by Sekisui Chemical Co., Ltd.) serving as a polyol and 15 parts of a blocked isocyanate (product name: DURANATE TPA-B80E, non-volatile content: 80% by mass, manufactured by Asahi Kasei Chemicals Corporation) were dissolved in a mixed solvent containing 73.5 parts of methyl ethyl ketone and 73.5 parts of 1-butanol. 80.8 Parts of the surface-treated zinc oxide particles A and 0.81 part of 2,3,4-trihydroxybenzophenone (manufactured by Tokyo Chemical Industry Co., Ltd.) were added to the solution, and the materials were dispersed for 3 hours in a sand mill apparatus using glass beads each having a diameter of 0.8 mm under an atmosphere of 23±3° C.

After the dispersion treatment, 0.01 part of a silicone oil (product name: SH28PA, manufactured by Dow Corning Toray Co., Ltd. (formerly: Dow Corning Toray Silicone Co., Ltd.)) and 5.6 parts of crosslinked polymethyl methacrylate (PMMA) particles (product name: TECHPOLYMER SSX-103, manufactured by Sekisui Kasei Co., Ltd., average primary particle diameter: 3 μm) were added to the resultant, and the mixture was stirred to prepare a coating liquid for an undercoat layer.

The resultant coating liquid for an undercoat layer was applied onto the above-mentioned support by dip coating to form a coating film, and the coating film was dried at 160° C. for 30 minutes to form an undercoat layer 2 having a thickness of 18 μm.

### <Surface Processing of Electrophotographic Photosensitive Member>

### (Polishing of Electrophotographic Photosensitive Member Before Surface Polishing)

The surface of the electrophotographic photosensitive member was polished. The polishing was performed with the polishing apparatus of FIG. 2 under the following conditions to produce the electrophotographic photosensitive member of Example 2-1.
Feed speed of polishing sheet: 400 mm/min
Number of revolutions of electrophotographic photosensitive member: 450 rpm
Indentation of electrophotographic photosensitive member into backup roller: 3.5 mm
Rotation directions of polishing sheet and electrophotographic photosensitive member: same
Backup roller: outer diameter: 100 mm, Asker C hardness: 25
Polishing sheet A to be mounted on polishing apparatus: polishing sheet surface roughness Ra: 1.12 μm

The time period for which the polishing was performed with the polishing sheet A was set to 20 seconds.

### (Measurement of Surface Roughness (μm))

The electrophotographic photosensitive member after the polishing was measured for its maximum height Rmax in accordance with JIS B 0601 1982 through use of a surface roughness measuring instrument SURFCORDER SE3500 manufactured by Kosaka Laboratory Ltd. The surface roughness Rmax of the electrophotographic photosensitive member after surface polishing was 0.75 μm.

### (Measurement Conditions)

Detector: R 2 μm
Stylus: A diamond stylus having a measuring force of 0.7 mN
Filter: 2CR
Cut-off value: 0.08 mm
Measurement length: 2.5 mm
Feed speed: 0.1 mm/sec

### Examples 1-2 to 1-5

Electrophotographic photosensitive members were produced in the same manner as in Example 1-1 except that, in the formation of the protective layer, the compound A was changed from the compound represented by the formula (CT5-1) to the compounds represented by the formulae (CT2-2-8) to (CT2-2-11) shown in Table 1.

### Examples 1-6 to 1-10

Electrophotographic photosensitive members were produced in the same manner as in Example 1-1 except that, in the formation of the protective layer, the compound A was changed from the compound represented by (CT5-1) to the compounds represented by the formulae (CT2-1-1) and (CT2-1-4) to (CT2-1-7) shown in Table 1.

### Example 1-11

An electrophotographic photosensitive member was produced in the same manner as in Example 1-6 except that the silicone-modified acrylic resin solution was excluded in the formation of the protective layer.

### Example 1-12

An electrophotographic photosensitive member was produced in the same manner as in Example 1-6 except that, in the formation of the protective layer, 60 parts by mass of the compound represented by the formula (CT2-1-1) was changed to 31 parts by mass of the compound represented by the formula (CT2-1-1) and 29 parts by mass of the compound represented by the formula (CT3-1).

### Example 1-13

An electrophotographic photosensitive member was produced in the same manner as in Example 1-6 except that, in the formation of the protective layer, 60 parts by mass of the compound represented by the formula (CT2-1-1) was changed to 24 parts by mass of the compound represented by the formula (CT2-1-1) and 36 parts by mass of the compound represented by the formula (CT3-1).

### Example 1-14

An electrophotographic photosensitive member was produced in the same manner as in Example 1-6 except that, in the formation of the protective layer, 60 parts by mass of the compound represented by the formula (CT2-1-1) was changed to 42 parts by mass of the compound represented by the formula (CT2-1-1) and 18 parts by mass of the compound represented by the formula (CT3-1).

### Example 1-15

An electrophotographic photosensitive member was produced in the same manner as in Example 1-6 except that, in the formation of the protective layer, 60 parts by mass of the compound represented by the formula (CT2-1-1) was changed to 42 parts by mass of the compound represented by the formula (CT2-1-1) and 18 parts by mass of the compound represented by the formula (CT4-1).

### Example 1-16

An electrophotographic photosensitive member was produced in the same manner as in Example 1-6 except that, in the formation of the protective layer, 60 parts of the compound represented by the formula (CT2-1-1) was changed to 42 parts by mass of the compound represented by the formula (CT2-1-1) and 18 parts by mass of the compound represented by the formula (CT3-2).

### Examples 2-2 to 2-16

The electrophotographic photosensitive members of Examples 1-2 to 1-16 were each subjected to surface processing after the undercoat layer 1 had been changed to the undercoat layer 2, and the charge-generating layer, the charge-transporting layer, and the protective layer of [Example 2-1] had been formed thereon, in the same manner as in [Example 2-1].

The surface roughness Rmax was 0.75 μm in all cases.

### Comparative Example 1-1

An electrophotographic photosensitive member was produced in the same manner as in Example 1-1 except that, in the formation of the protective layer, the polymerizable charge-transporting compound represented by the exemplary compound (CT5-1) was changed to a polymerizable charge-transporting compound represented by the following formula (CT5-2), and the conditions for irradiating the coating film with the electron beam were changed to the conditions of an acceleration voltage of 70 kV and an absorbed dose of 15 kGy for 1.6 seconds.

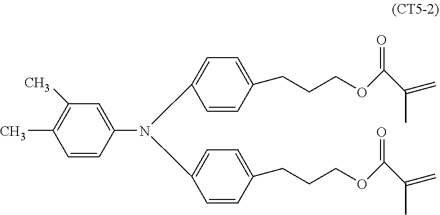 [SMILES: C=C(C)C(=O)OCCCc1ccc(N(c2ccc(CCCOC(=O)C(=C)C)cc2)c2ccc(C)c(C)c2)cc1]

### Comparative Example 1-2

In the formation of the protective layer, the coating liquid for a protective layer was changed to a coating liquid for a protective layer for UV curing obtained by mixing 50 parts by mass of a polymerizable charge-transporting compound represented by the following formula (CT5-3) with 75 parts by mass of THF and 75 parts by mass of isopropanol, and adding 0.25 part by mass of a photopolymerization initiator (1-hydroxy-cyclohexyl-phenyl-ketone, Irgacure 184, manufactured by Ciba Specialty Chemicals Inc.). The coating liquid was applied onto the charge-transporting layer by dip coating, then dried at 60° C. for 5 minutes, irradiated with UV light at 600 W for 15 seconds, and then dried at 130° C. for 30 minutes. An electrophotographic photosensitive member was produced by forming a protective layer having a thickness of 5.0 μm in the same manner as in Example 1-1 except for the foregoing.

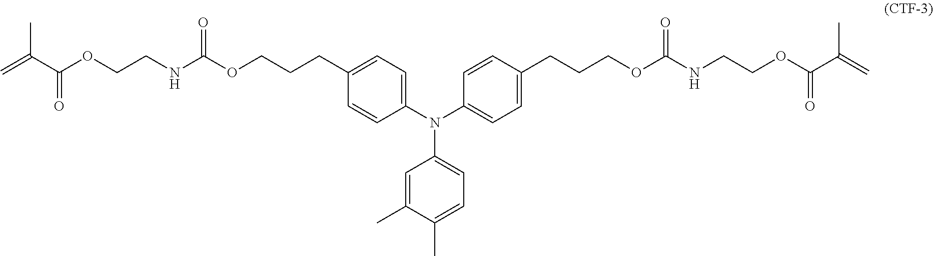 [SMILES: C=C(C)C(=O)OCCNC(=O)OCCCc1ccc(N(c2ccc(CCCOC(=O)NCCOC(=O)C(=C)C)cc2)c2ccc(C)c(C)c2)cc1]

### Comparative Example 1-3

An electrophotographic photosensitive member having a thickness of 5.0 μm was produced in the same manner as in Comparative Example 1-2 except that, in the formation of the protective layer, 50 parts by mass of the polymerizable charge-transporting compound represented by the formula (CT5-3) was changed to 25 parts by mass of the polymerizable charge-transporting compound represented by the formula (CT5-3) and 25 parts by mass of the polymerizable compound represented by the formula (CT3-1).

### Comparative Example 1-4

An electrophotographic photosensitive member having a thickness of 5.0 μm was produced in the same manner as in Comparative Example 1-2 except that, in the formation of the protective layer, 50 parts by mass of the polymerizable charge-transporting compound represented by the formula (CT5-3) was changed to 25 parts by mass of a polymerizable charge-transporting compound represented by the formula (CT5-4) and 25 parts by mass of the polymerizable compound represented by the formula (CT3-2).

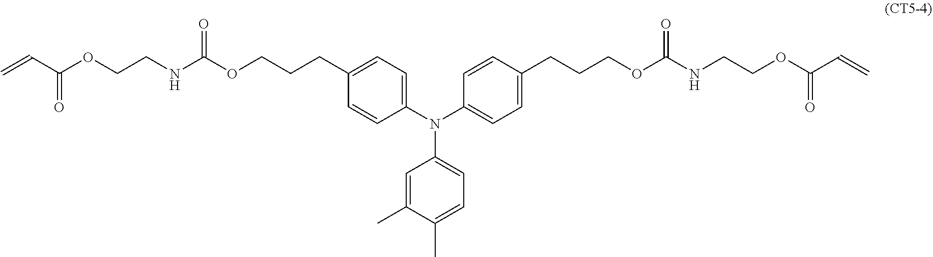

### Comparative Examples 2-1 to 2-4

The electrophotographic photosensitive members of Comparative Examples 1-1 to 1-4 were each subjected to surface processing after the undercoat layer 1 had been changed to the undercoat layer 2, and the charge-generating layer, the charge-transporting layer, and the protective layer of [Example 2-1] had been formed thereon, in the same manner as in [Example 2-1].

With regard to Examples 1-1 to 1-16 and Comparative Examples 1-1 to 1-4, the load decrease rate (W1-W2)/W1 and displacement amount ratio ht/hc of each protective layer are shown in Table 2 below.

TABLE 2

| | Polymerizable | Polymerizable | | | | |
|---|---|---|---|---|---|---|
| | charge- | non-charge- | Urethane | | | |
| | transporting | transporting | group:methacryloyl | Formula (1) | Formula (2) (W1 − | Formula (3) |
| | compound | compound | group | 25 < W1 < 60 | W2)/W1 ≤ 0.10 | ht/hc ≥ 1.5 |
| Example 1-1 | CT5-1 | None | 1.0 | 30 | 0.09 | 1.5 |
| Example 1-2 | CT2-2-8 | None | 0.5 | 35 | 0.06 | 1.6 |
| Example 1-3 | CT2-2-9 | None | 0.5 | 34 | 0.06 | 1.7 |
| Example 1-4 | CT2-2-10 | None | 0.67 | 34 | 0.06 | 1.7 |
| Example 1-5 | CT2-2-11 | None | 0.8 | 34 | 0.06 | 1.6 |
| Example 1-6 | CT2-1-1 | None | 0.5 | 35 | 0.06 | 2.0 |
| Example 1-7 | CT2-1-4 | None | 0.67 | 34 | 0.06 | 1.9 |
| Example 1-8 | CT2-1-5 | None | 0.5 | 35 | 0.03 | 1.9 |
| Example 1-9 | CT2-1-6 | None | 0.6 | 35 | 0.03 | 1.8 |
| Example 1-10 | CT2-1-7 | None | 0.75 | 34 | 0.03 | 1.8 |
| Example 1-11 | CT2-1-1 | None | 0.5 | 35 | 0.03 | 2.0 |
| Example 1-12 | CT2-1-1 | CT3-1 | 0.4 | 27 | 0.06 | 1.7 |
| Example 1-13 | CT2-1-1 | CT3-1 | 0.38 | 26 | 0.08 | 1.9 |
| Example 1-14 | CT2-1-1 | CT3-1 | 0.43 | 29 | 0.02 | 1.8 |
| Example 1-15 | CT2-1-1 | CT4-1 | 0.43 | 29 | 0.01 | 1.9 |
| Example 1-16 | CT2-1-1 | CT3-2 | 0.5 | 28 | 0.02 | 1.5 |
| Comparative | CT5-2 | None | 0 | 34 | 0.10 | 1.1 |
| Example 1-1 | | | | | | |
| Comparative | CT5-3 | None | 1.0 | 34 | 0.18 | 1.9 |
| Example 1-2 | | | | | | |
| Comparative | CT5-3 | CT3-1 | 0.36 | 20 | 0.14 | 1.3 |
| Example 1-3 | | | | | | |
| Comparative | CT5-4 | CT3-2 | 2.0 | 30 | 0.15 | 1.3 |
| Example 1-4 | | | | | | |

### <Evaluation of Electrophotographic Photosensitive Member>

The electrophotographic photosensitive members obtained in Examples 1-1 to 1-16 and Comparative Examples 1-1 to 1-4, and Examples 2-1 to 2-16 and Comparative Examples 2-1 to 2-4 were evaluated as described below.

### Evaluation Apparatus 1

An evaluation was performed by mounting each of the electrophotographic photosensitive members produced in Examples 1-1 to 1-16 and Comparative Examples 1-1 to 1-4 on a copying machine imageRUNNER ADVANCE DX C3830 (product name) manufactured by CANON KABUSHIKI KAISHA.

Specifically, the above-mentioned evaluation apparatus was placed under a normal-temperature and normal-humidity environment having a temperature of 23° C. and a relative humidity of 50% RH, and each of the produced electrophotographic photosensitive members was mounted onto a process cartridge for a cyan color. The resultant was mounted onto the station of the process cartridge for a cyan color, and the evaluation was performed.

### Evaluation Apparatus 2

An evaluation was performed by mounting each of the electrophotographic photosensitive members produced in Examples 2-1 to 2-16 and Comparative Examples 2-1 to 2-4 on a copying machine imageRUNNER ADVANCE C5255 manufactured by CANON KABUSHIKI KAISHA.

Specifically, the above-mentioned evaluation apparatus was placed under a normal-temperature and normal-humidity environment having a temperature of 23° C. and a relative humidity of 50% RH, and each of the produced electrophotographic photosensitive members was mounted onto a process cartridge for a cyan color. The resultant was mounted onto the station of the process cartridge for a cyan color, and the evaluation was performed.

### (Evaluation of Scratch Resistance)

The evaluation of scratch resistance was performed by using the evaluation apparatus 1 and the evaluation apparatus 2 described above. First, the electrophotographic apparatus and the electrophotographic photosensitive member were left standing in an environment having a temperature of 23° C. and a humidity of 50% RH for 24 hours or more, and then the electrophotographic photosensitive member was mounted onto the cartridge for a cyan color of the electrophotographic apparatus. Next, an image having a print ratio of 5% was output in a cyan single color on A4-size plain paper, and the image was continuously output on 300,000 sheets.

A solid white image, a solid black image, and a halftone image were each output for an image evaluation, and visual observation was performed as to whether streaks due to scratches on the surface of the photosensitive member occurred on the images. The number of generated scratches each having a length of 2 mm or more was counted, and a total count number in each image was evaluated. As the number of generated scratches becomes smaller, abrasion resistance becomes more excellent.

The results of the evaluations of the electrophotographic photosensitive members produced in Examples 1-1 to 1-16 and Comparative Examples 1-1 to 1-4, and Examples 2-1 to 2-16 and Comparative Examples 2-1 to 2-4 performed with the evaluation apparatus 1 and the evaluation apparatus 2 are shown in Table 3.

TABLE 3

| | Evaluation | | Evaluation |
|---|---|---|---|
| | apparatus 1 | | apparatus 2 |
| | Number of | | Number of |
| Evaluation results | scratches | | scratches |
| Example 1-1 | 16 | Example 2-1 | 21 |
| Example 1-2 | 9 | Example 2-2 | 12 |
| Example 1-3 | 9 | Example 2-3 | 12 |
| Example 1-4 | 9 | Example 2-4 | 12 |
| Example 1-5 | 9 | Example 2-5 | 12 |
| Example 1-6 | 9 | Example 2-6 | 12 |
| Example 1-7 | 10 | Example 2-7 | 15 |
| Example 1-8 | 7 | Example 2-8 | 9 |
| Example 1-9 | 8 | Example 2-9 | 10 |
| Example 1-10 | 8 | Example 2-10 | 10 |
| Example 1-11 | 6 | Example 2-11 | 8 |
| Example 1-12 | 9 | Example 2-12 | 12 |
| Example 1-13 | 12 | Example 2-13 | 18 |
| Example 1-14 | 3 | Example 2-14 | 5 |
| Example 1-15 | 3 | Example 2-15 | 5 |
| Example 1-16 | 4 | Example 2-16 | 5 |
| Comparative | 20 | Comparative | 25 |
| Example 1-1 | | Example 2-1 | |
| Comparative | 18 | Comparative | 28 |
| Example 1-2 | | Example 2-2 | |
| Comparative | 25 | Comparative | 30 |
| Example 1-3 | | Example 2-3 | |
| Comparative | 24 | Comparative | 29 |
| Example 1-4 | | Example 2-4 | |

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-021080, filed Feb. 12, 2025, which is hereby incorporated by reference herein in its entirety.

What is claimed is:

1. An electrophotographic photosensitive member comprising a surface layer containing a polymerized product obtained by polymerizing a polymerizable composition containing a compound A having a urethane structure and a methacryloyl group,
wherein when, in a load-displacement curve measured by a dynamic nanoindentation method, a measured load value at a start of holding in a section in which a load is held for a certain time period is represented by W1, a measured load value at an end of the holding is represented by W2, a maximum displacement amount at the end of the holding is represented by ht, and an X-axis intersection point of a tangent line of an unloading curve at a point W2 (contact depth of an indenter) is represented by hc, the electrophotographic photosensitive member satisfies the following formulae (1) to (3).
$$25 < W 1 < 60 \qquad Formula ( 1 )$$
$$( W 1 - W 2 ) / W 1 \leq 0.1 \qquad Formula ( 2 )$$
$$ht / hc \geq 1.5 \qquad Formula ( 3 )$$

2. The electrophotographic photosensitive member according to claim 1, wherein the compound A has a group represented by the following formula (CT-1): 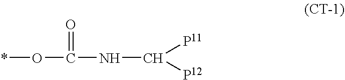
in the formula (CT-1), P¹¹ and P¹² each independently represent a group represented by the following formula (P-1), and * represents a bonding site: 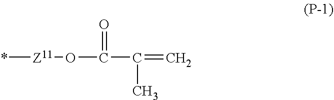
in the formula (P-1), Z¹¹ represents an alkylene group having 1 to 4 carbon atoms, and * represents a bonding site.

3. The electrophotographic photosensitive member according to claim 1, wherein the compound A is represented by one of the following formula (CT-2-1) or the following formula (CT-2-2): 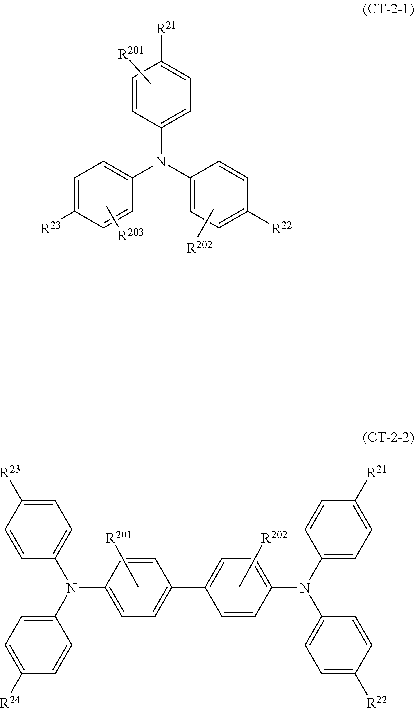
in the formula (CT-2-1) and the formula (CT-2-2), at least one of R²¹ to R²⁴ represents a group represented by the following formula (A), and others each independently represent a hydrogen atom, a methyl group, a group represented by the following formula (A), or a group represented by the following formula (B), R²⁰¹ to R²⁰³ each represent a hydrogen atom or a methyl group: 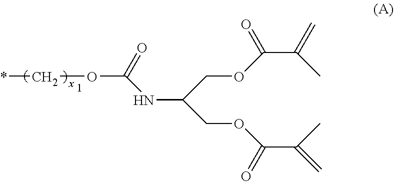
in the formula (A), X₁ represents an integer of from 0 to 3, and * represents a bonding site; 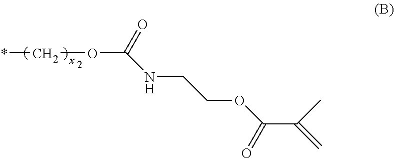
in the formula (B), X₂ represents an integer of from 0 to 3, and * represents a bonding site.

4. The electrophotographic photosensitive member according to claim 1, wherein the polymerizable composition further contains a compound represented by one of the following formula (CT-3) or the following formula (CT-4): 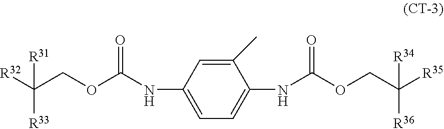
in the formula (CT-3), R³¹ to R³⁶ each independently represent an acryloyl group, a methacryloyl group, a hydrogen atom, or a methyl group; 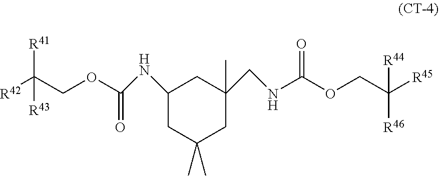
in the formula (CT-4), R⁴¹ to R⁴⁶ each independently represent an acryloyl group, a methacryloyl group, a hydrogen atom, or a methyl group.

5. The electrophotographic photosensitive member according to claim 1, wherein, in the polymerizable composition, a ratio of the urethane structure to the methacryloyl group is 0.43 or more and 0.90 or less in terms of molar ratio.

6. The electrophotographic photosensitive member according to claim 1, wherein, in the polymerizable composition, a ratio of the compound represented by one of the formula (CT-3) or the formula (CT-4) to the compound A is 0.49 or less in terms of mass ratio.

7. The electrophotographic photosensitive member according to claim 1, wherein the compound A is a charge-transporting compound.

8. The electrophotographic photosensitive member according to claim 1, wherein the polymerizable composition further contains a silicone compound having one of an acryloyloxy group or a methacryloyloxy group.

9. A method of producing the electrophotographic photosensitive member of claim 1,
the method comprising a polymerization step of forming a coating film using a coating liquid for a surface layer containing a compound having a group represented by the following formula (CT-1), and polymerizing the polymerizable compound in the coating film to form a surface layer,
wherein the polymerization step includes polymerizing the compound by irradiation with an electron beam: 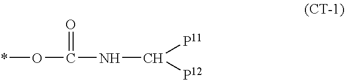
in the formula (CT-1), P¹¹ and P¹² each independently represent a group represented by the following formula (P-1), and * represents a bonding site: 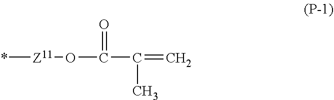
in the formula (P-1), Z¹¹ represents an alkylene group having 1 to 4 carbon atoms, and * represents a bonding site.

10. A process cartridge comprising:
the electrophotographic photosensitive member of claim 1; and
at least one unit selected from the group consisting of: a charging unit; a developing unit; a transfer unit; and a cleaning unit,
the process cartridge integrally supporting the electrophotographic photosensitive member and the at least one unit, and being detachably attachable to a main body of an electrophotographic apparatus.

11. An electrophotographic apparatus comprising:
the electrophotographic photosensitive member of claim 1;
a charging unit;
an exposing unit;
a developing unit; and
a transfer unit.
